(19) United States
(12) Patent Application Publication
(10) Pub. No.: US 2011/0140998 A1
(43) Pub. Date: Jun. 16, 2011

(54) Reading Device

(76) Inventors: Chih-Kuei Hu, Jubei (TW); Wei-Ting Liu, Hacienda Heights, CA (US); Wei-Hua Lu, Taipei (TW)

(21) Appl. No.: 12/639,939

(22) Filed: Dec. 16, 2009

(51) Int. Cl. G09G 3/30

(52) U.S. Cl. 345/77

(57) ABSTRACT

A reading device includes an electronic paper, a frame, a light detector and a light source. The electronic paper is used for displaying a reading data; the frame is used for holding the electronic paper; the light detector is used for detecting the ambient light and generating a detecting signal according to the ambient light; and the light source, located on edge of the frame, is capable of adaptively emitting light according to the detecting signal.

### BACKGROUND OF THE INVENTION

1. Field of the Invention

The present invention relates to a reading device, and more particularly, to a reading device having the electronic paper with adjustable light source or content.

2. Description of the Prior Art

It has been suggested that electronic paper for converting an electrical action into an optical action be used as display devices of various types of electronic apparatuses, such as monitor, mobile phone or PDAs (Personal Digital Assistants). Electronic paper comprises a layer of electro-phoretic material, a term which is used herein in its conventional meaning in the imaging art to refer to a material having first and second display states differing in at least one optical property, the material being changed from its first to its second display state by application of an electric field to the material.

Please refer to FIG. 1, which discloses a conventional reading device with electronic paper. The electronic paper 100 includes the top electrode 102, the bottom electrode 104 and the electronic ink 106. The top electrode 102 is transparent and the bottom electrode 104 is segmented for individually controlling the electronic ink 106. The controller 108 provides a control voltage to the electronic paper 100. When control voltages are applied between the top electrode 104 and the bottom electrode 104, the state of the electronic ink 106 will be changed to either white condition or black condition. The electronic ink 106 in white condition can reflect the ambient light 110 to user's eyes 112, and the electronic ink 106 in black condition can absorb the ambient light 110. This kind of characteristic makes the electronic paper 100 can show text or pictures according to the control voltage provided by the controller 108.

One important application of electronic paper is in portable electronic devices, where convenience is an important consideration, and thus users can read text or picture anywhere and anytime. The conventional reading device utilizes reflecting ambient light to show content of the electronic paper. When the environment is too dark or too bright, the text or picture shown on the electronic paper will be indistinct and the users will be difficult to use the reading device.

### SUMMARY OF THE INVENTION

It is therefore an objective of the present invention to provide a reading device having adjustable light source or content of the electronic paper.

The present invention discloses a reading device having an electronic paper, a frame, a light detector and a light source. The electronic paper is used for displaying a reading data; the frame is used for holding the electronic paper; the light detector is used for detecting the ambient light and generating a detecting signal according to the ambient light; and the light source, located on edge of the frame, is capable of adaptively emitting light according to the detecting signal.

The present invention also discloses a reading device having an electronic paper and a light detector. The electronic paper is used for displaying a reading data; and the light detector is used for detecting the ambient light and generating a detecting signal according to the ambient light. Content of the reading data displayed on the electronic paper is capable of being adaptively adjusted according to the detecting signal.

The present invention further discloses a method for driving a reading device. The reading device comprises an electronic paper for displaying a reading data and a light detector for detecting the ambient light. The method comprises: utilizing the light detector to generate a detecting signal according to the ambient light; and adaptively adjusting a content of the reading data according to the detecting signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a conventional electronic paper.

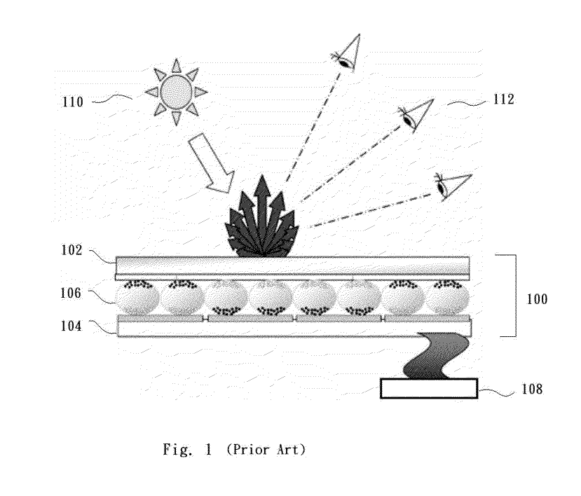

FIG. 2 shows the first embodiment of the present invention.

FIG. 3 shows the second embodiment of the present invention.

FIG. 4 shows the third embodiment of the present invention.

FIG. 5 shows the fourth embodiment of the present invention.

FIG. 6 shows a method for adjusting content of the electronic paper.

FIG. 7 shows the fifth embodiment of the present invention.

FIG. 8 shows the sixth embodiment of the present invention.

### DETAILED DESCRIPTION

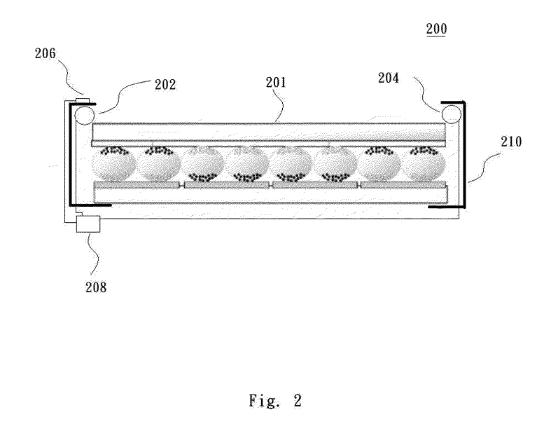

Please refer to FIG. 2, which discloses the first embodiment of the present invention. In FIG. 2, the reading device 200 includes the electronic paper 201, the light sources 202 and 204, the light detector 206 and the frame 210. The electronic paper 201 is used for displaying text or picture, the light detector 206 is used for detecting the ambient light, the light sources 202 and 204 are used for emitting light, and the frame 210 is used for holding the electronic paper 201 and placing the light sources 202 and 204. The light sources 202 and 204 could be dot light sources, such as light emitting diode (LED), or line light sources, such as cold cathode fluorescent lamp (CCFL). The electronic paper could be a bi-stable electro-phoretic display which reflects light to user's eyes or absorbs light to show black content.

The light detector 206 can detect the ambient light and generate a detecting signal according to the ambient light. The detecting signal can be sent to the light sources 202 and 204 to directly control the brightness of the light sources 202 and 204. Or, the detecting signal can be also sent to a controller 208 to control brightness of the light sources 202 and 204. These changes all obey the spirit of the present invention. The light sources 202 and 204, which are located on edge of the frame 210, can adaptively emit light according to the detecting signal from the light detector 206. When the ambient light is dim, the light detector 206 can generate a detecting signal to control the light sources 202 and 204 to heighten the brightness. Light from the light sources 202 and 204 can be reflected or absorbed by the electronic ink in the electronic paper 201, and the insufficiency of ambient light can be compensated by the light sources 202 and 204. In summary, brightness of the electronic paper can be maintained within a predetermine range that suitable for user to read, and brightness of the electronic paper is adjusted according to the ambient light.

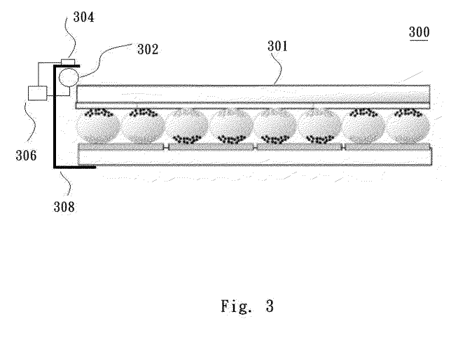

Please refer to FIG. 3, which discloses the second embodiment of the present invention. In FIG. 3, the reading device 300 includes the electronic paper 301, the light source 302, the light detector 304 and the frame 308. Function of the second embodiment is similar to that of the first one, except the light source 302 is located on simply one end of the reading device 300. The light detector 304 can detect the ambient light and generate a detecting signal according to the ambient light. The detecting signal can be sent to the light source 302 to directly control the brightness of the light source 302, or the detecting signal can be also sent to a controller 306 to control brightness of the light source 302.

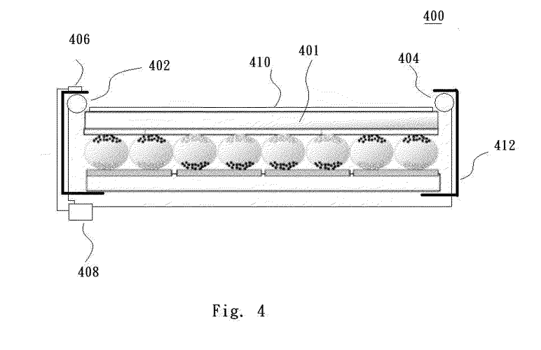

Please refer to FIG. 4, which discloses the third embodiment of the present invention. In FIG. 4, the reading device 400 includes the electronic paper 401, the light sources 402 and 404, the light detector 406, the light guide layer 410 and the frame 412. The electronic paper 401 is used for displaying text or picture, the light detector 406 is used for detecting the ambient light, the light sources 402 and 404 are used for emitting light, and the frame 412 is used for holding the electronic paper 401 and placing the light sources 402 and 404. This embodiment comprises a light guide layer 410 for guiding light from the light sources 402 and 404 to whole electronic paper 401. The light guide layer 410 can guide light to a predetermined direction and therefore average light from the light sources 402 and 404.

The light detector 406 can detect the ambient light and generate a detecting signal according to the ambient light. The detecting signal can be sent to the light sources 402 and 404 to directly control the brightness of the light sources 402 and 404, or the detecting signal can be also sent to a controller 408 to control brightness of the light sources 402 and 404. The light sources 402 and 404, which are located on edge of the frame 412, can adaptively emit light according to the detecting signal from the light detector 406. When the ambient light is dim, the light detector 406 can generate a detecting signal to control the light sources 402 and 404 to heighten the brightness. Light from the light sources 402 and 404 can be guided by the light guide layer 410 to the whole electronic paper 401, and the light can be reflected or absorbed by the electronic ink in the electronic paper 401. Therefore, the insufficiency of ambient light can be compensated by the light sources 402 and 404.

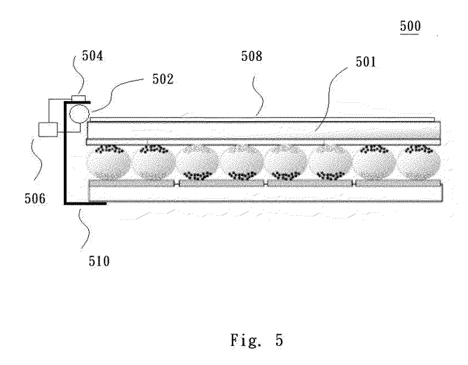

Please refer to FIG. 5, which discloses the fourth embodiment of the present invention. In FIG. 5, the reading device 500 includes the electronic paper 501, the light source 502, the light detector 504, the light guide layer 508 and the frame 510. Function of the fourth embodiment is similar to that of the third embodiment, except the light source 502 is located on simply one end of the reading device 500. The light detector 504 can detect the ambient light and generate a detecting signal according to the ambient light. The detecting signal can be sent to the light source 502 to directly control the brightness of the light source 502, or the detecting signal can be also sent to a controller 506 to control brightness of the light source 502. Light from the light source 502 can be guided by the light guide layer 508 to the whole electronic paper 501, and the light can be reflected or absorbed by the electronic ink in the electronic paper 501. Therefore, the insufficiency of ambient light can be compensated by the light source 502.

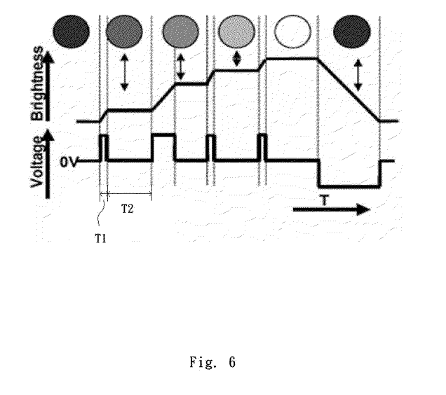

The contrast and the gray level of the electronic paper can be adjusted by controlling the driving voltage. Please refer to FIG. 6, which discloses one method for adjusting the contrast and the gray level of the electronic paper. In FIG. 6, Voltage means the driving voltage applied between the top electrode and the bottom electrode, and Brightness means the light reflected by the electronic paper. T1 is the address time, and T2 is the waiting time. The gray level of the electronic paper can be changed according to the pulse width of the driving voltage. By changing the addressing time T1 and the waiting time T2, the pulse width of the driving voltage can be changed, and so that the gray level of the electronic paper can be adjusted.

Another method for adjusting the contrast and the gray level of the electronic paper could be changing the amplitude of the driving voltage. Please note, the above embodiment utilizes a PWM driving mechanism, and this mechanism is not a limitation of this invention. For example, the driving mechanism can be implemented with a digital to analog driving mechanism. The driving digital data will be converted into analog driving voltage. For example, the driving voltage of the electronic paper could be +15V to −15V, +15V is the white state and −15V is the black state, and vice versa. The driving voltage can be therefore divided into 6 levels between −15V and +15V to show 6 gray levels.

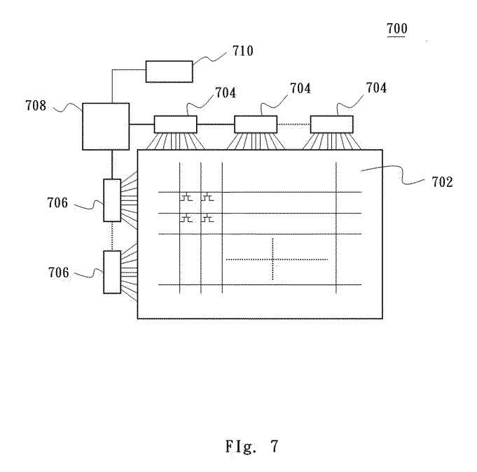

Please refer to FIG. 7, which discloses the fifth embodiment of the present invention. In FIG. 7, the reading device 700 comprises the electronic paper 702, the column driver 704, the row driver 706, the controller 708 and the light detector 710. The electronic paper 702 is used for displaying text or picture, the column driver 704 and the row driver 706 are used for driving the electronic paper 702, the controller 708 is used for providing the driving voltage and timing signal to the column driver 704 and the row driver 706 respectively, and the light detector 710 is used for detecting the ambient light. The electronic paper could be a bi-stable electro-phoretic display which reflects light to user's eyes or absorbs light to show black content.

The light detector 710 can detect the ambient light and generate a detecting signal according to the ambient light. The light detector 710 provides the detecting signal to the controller 708, and therefore the controller 708 can adjust the driving voltage according to the detecting signal. Since the driving voltages of the column driver 704 or the row driver 706 are changed, the content of the reading data displayed on the electronic paper is also changed accordingly. In the present invention, changing the content of the reading data could also change the contrast or the gray level of the reading data to maintain the visual effect of the electronic paper. For example, when the ambient light is dim, the light detector 710 can generate a detecting signal to the controller 708, and then the controller adjusts the amplitude or the pulse width of the driving voltage and provides the adjusted driving voltage to the column driver 704. The column driver 704 drives the electronic paper 702 with adjusted amplitude or pulse width of the driving voltage, and therefore the visual contrast of the displayed data is changed. Since the visual contrast of the electronic paper 702 is enhanced according to the detection of the ambient light, the insufficiency of ambient light can be compensated by the adjustment of the driving voltage. In summary, the visual contrast of the electronic paper can be maintained within a predetermine range that suitable for user to read, and the visual contrast of the electronic paper is adjusted according to the ambient light.

While the controller 708 adjusts the driving voltage according to the detecting signal, the above-mentioned methods can be utilized to achieve, which include changing the amplitude or the pulse width of the driving voltage. Besides, more than one driving voltage set can be designed in the controller 708, and the controller 708 can provide different set of driving voltage to the data driver according to different detecting signal. For example, the first set of driving voltage is averagely divided into 6 levels between −15V and +15V to show 6 gray levels, and the second set of driving voltage is unevenly divided into 6 levels between −15V and +15V to show another 6 gray levels. The controller 708 selects one of the driving voltage sets according to the detecting signal, and provides the selected driving voltage set to the column driver 704 or the row driver 706.

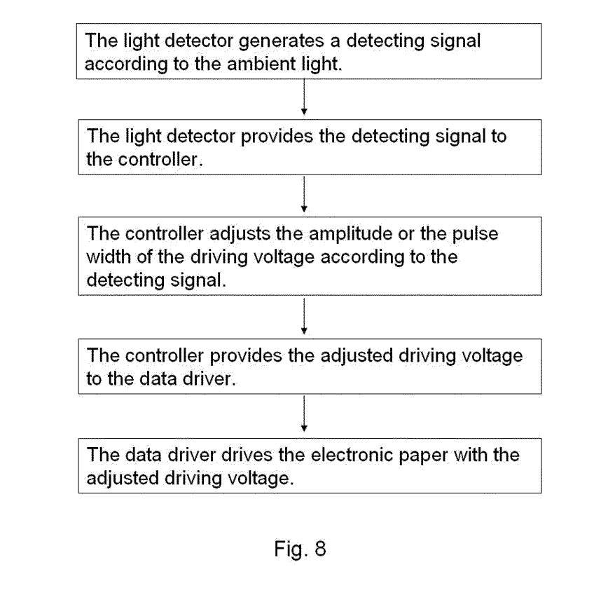

Please refer to FIG. 8, which discloses the sixth embodiment of the present invention. The sixth embodiment further discloses a method for driving a reading device. The reading device comprises an electronic paper for displaying a reading data and a light detector for detecting an ambient light. The method comprising: utilizing the light detector to generate a detecting signal according to the ambient light; and adaptively adjusting a content of the reading data according to the detecting signal. The step of adjusting the content of the reading data can be achieved by adjusting the contrast or the gray level of the reading data. The light detector can generate a detecting signal to the controller, and then the controller adjusts the amplitude or the pulse width of the driving voltage and provides the adjusted driving voltage to the data driver. The data driver drives the electronic paper with adjusted amplitude or pulse width of the driving voltage, and therefore the visual contrast of the displayed data is changed.

In addition, the above-mentioned embodiments are regarded as examples, not limitations of the present invention. Please note, the present invention can adjust both the content and the light source to compensate the variances of the ambient lights.

Furthermore, the present invention can adjust the content and the light source in an optimized way. For example, for the same visual effect, the present invention can entirely adjust the luminance of the light source, entirely the content to raise the contrast, or partially adjust the luminance of the light source and partially adjust the content. Therefore, an optimized way can be determined according to different demands. For example, for low power consumption, the present invention can slightly adjust the luminance of the light source, and the improvement of the visual effect is mainly achieved by the adjustment of the image content. These changes all falls within the scope of the present invention.

Above mentioned embodiments and drawings utilize E-Ink material for the electronic paper, but other bistable materials, such as microcup, could replace E-Ink material and shall not be a limitation of present invention.

Those skilled in the art will readily observe that numerous modifications and alterations of the device and method may be made while retaining the teachings of the invention.

What is claimed is:

1. A reading device, comprising:
an electronic paper for displaying a reading data;
a frame for holding the electronic paper;
a light detector for detecting an ambient light and generating a detecting signal according to the ambient light; and
a light source, located on edge of the frame, capable of adaptively emitting light according to the detecting signal.

2. The reading device of claim 1 further comprising a light guide layer located on the electronic paper for guiding light of the light source to the electronic paper.

3. The reading device of claim 1, wherein the light source is a light emitting diode (LED).

4. The reading device of claim 1, wherein the light source is a cold cathode fluorescent lamp (CCFL).

5. The reading device of claim 1, wherein the electronic paper is a bi-stable electro-phoretic display.

6. The reading device of claim 1, wherein brightness of the electronic paper is maintained within a predetermine range by adjusting the light source.

7. A reading device, comprising:
an electronic paper for displaying a reading data; and
a light detector for detecting an ambient light and generating a detecting signal according to the ambient light;
wherein a content of the reading data displayed on the electronic paper is capable of being adaptively adjusted according to the detecting signal.

8. The reading device of claim 7, wherein the electronic paper is a bi-stable electro-phoretic display.

9. The reading device of claim 7, wherein a contrast of the reading data is adaptively adjusted according to the detecting signal.

10. The reading device of claim 9, wherein the contrast of the reading data is adaptively adjusted according to the detecting signal to substantially maintain visual contrast of the electronic paper.

11. The reading device of claim 7, wherein a gray level of the reading data is adaptively adjusted according to the detecting signal.

12. The reading device of claim 11, wherein the gray level of the reading data is adaptively adjusted according to the detecting signal to substantially maintain visual contrast of the electronic paper.

13. The reading device of claim 7, further comprising a data driver for providing a driving voltage to the electronic paper to display the reading data, wherein an amplitude of the driving voltage is adaptively adjusted according to the detecting signal.

14. The reading device of claim 7, further comprising a data driver for providing a driving voltage to the electronic paper to display the reading data, wherein a pulse width of the driving voltage is adaptively adjusted according to the detecting signal.

15. A method for driving a reading device, the reading device comprises an electronic paper for displaying a reading data and a light detector for detecting an ambient light, the method comprising:
utilizing the light detector to generate a detecting signal according to the ambient light; and
adaptively adjusting a content of the reading data according to the detecting signal.

16. The method of claim 15, wherein the step of adjusting the content of the reading data comprises: adjusting a contrast of the reading data.

17. The method claim 15, wherein the step of adjusting the content of the reading data comprises: adjusting a gray level of the reading data.

18. The method of claim 15, wherein the reading device further comprises a data driver for providing a driving voltage to the electronic paper to display the reading data, and the step of adjusting the content of the reading data comprises: adjusting an amplitude of the driving voltage.

19. The method of claim 15, wherein the reading device further comprises a data driver for providing a driving voltage to the electronic paper to display the reading data, and adjusting the content of the reading data comprises: adjusting a pulse width of the driving voltage.

20. The method of claim 15, wherein the reading device further comprises a light source located on edge of the reading device, and the method further comprising: adaptively emitting light according to the detecting signal.
